(19) United States
(12) Patent Application Publication
(10) Pub. No.: US 2017/0109686 A1
(43) Pub. Date: Apr. 20, 2017

(54) Techniques for Replenishing Products Based on Real-time Data Ingested from Internet Enabled Devices

(71) Applicant: SuccessFactors, Inc., South San Francisco, CA (US)

(72) Inventors: SUNIL KAMADOLLI, Sunnyvale, CA (US); NIYANTH KUDUMULA, Mountain View, CA (US); KRISHNADAS MENON, Fremont, CA (US); MATT SPOHN, West Chester, PA (US)

(21) Appl. No.: 14/885,762

(22) Filed: Oct. 16, 2015

(51) Int. Cl. G06Q 10/08; G06Q 30/08; G06Q 30/02; G06Q 30/06

(52) U.S. Cl. CPC G06Q 10/087; G06Q 30/0605; G06Q 30/08; G06Q 30/0206

(57) ABSTRACT

A system is disclosed for replenishing products that are being monitored by an internet enabled device. The internet enabled device can monitor products to provide real-time replenishment data. The real-time replenishment data can be analyzed to form real-time consumption patterns. Based on the real-time consumption patterns, a determination can be made as to which products being monitored by the internet enabled device requires replenishment. To replenish the products, the system can query local retailers that carry the product. This can include initiating bids and sending the bids out to local retailers. Based on an analysis of the local retailers and the consumer's needs, a recommendation of a local retailers can be provided. The local retailer is a place where the consumer can purchase the product.

### BACKGROUND

A typical product supply chain goes from the manufacturer to the retailer and finally to the consumer. The manufacturer creates products which are in turn sold in bulk to retailers. The retailers stock the products in retail stores where they are offered for sale to consumers. Consumers visit the retail stores, purchase the products, and eventually consume the product.

Each party involved in the product supply chain faces unique challenges. For example, consumers can have difficulty locating retailers that carry their favorite products at the best prices. Retailers can have difficulty maintaining the right stock of products since products which are not purchased (particularly perishable items) can result in a lost profits. Similarly, manufacturers have difficulty generating the right products to meet the demands of the consumer. Manufacturers typically get feedback from retailers on what products to generate and that feedback may not be in line with the customer's actual needs. Thus, there is a need to optimize the product supply chain.

### SUMMARY

In one embodiment, a computer-implemented method receives, by a processor and from an internet enabled device, replenishment data associated with a first product being monitored by the internet enabled device. The method then generates, by the processor and in accordance to the replenishment data, a prediction that the first product is going to be depleted within a predefined period of time. In response to the prediction, the method then performs the steps of: identifying, by the processor, a first plurality of retailers who carry the first product, transmitting, by the processor, a request to the first plurality of retailers requesting a bid for the first product, receiving, by the processor and from at least some of the first plurality of retailers, a price for the first product, and generating, by the processor, a primary recommendation based on the plurality of prices for the first product, the recommendation being one of the first plurality of retailers.

In another embodiment, a non-transitory computer readable storage medium stores one or more programs comprising instructions for receiving, from an internet enabled device, replenishment data associated with a first product being monitored by the internet enabled device, generating, in accordance to the replenishment data, a prediction that the first product is going to be depleted within a predefined period of time. In response to the prediction, the program performs the steps of: identifying a first plurality of retailers who carry the first product, transmitting a request to the first plurality of retailers requesting a bid for the first product, receiving, from at least some of the first plurality of retailers, a price for the first product, and generating a primary recommendation based on the plurality of prices for the first product, the recommendation being one of the first plurality of retailers.

In another embodiment, a computer implemented system comprises one or more computer processors memory; and one or more programs. The one or more programs are stored in the memory and configured to be executed by the one or more processors. The one or more programs include instructions for: receiving, from an internet enabled device, replenishment data associated with a first product being monitored by the internet enabled device, generating, in accordance to the replenishment data, a prediction that the first product is going to be depleted within a predefined period of time. In response to the prediction, the program performs the steps of: identifying a first plurality of retailers who carry the first product, transmitting a request to the first plurality of retailers requesting a bid for the first product, receiving, from at least some of the first plurality of retailers, a price for the first product, and generating a primary recommendation based on the plurality of prices for the first product, the recommendation being one of the first plurality of retailers.

### BRIEF DESCRIPTION OF THE DRAWINGS

FIG. 1 depicts a system environment 100 for consumption pattern analysis according to one embodiment.

FIG. 2 depicts a system for assisting a consumer in purchasing products which need replenishment according to one embodiment.

FIG. 3 depicts a system for providing useful insights to manufacturers and/or retailers according to one embodiment.

FIG. 4 depicts an example of a user interface presented on a consumer device according to one embodiment.

FIG. 5 depicts an example of a dashboard that is presented to local retailers according to one embodiment.

FIG. 6 depicts an example of a dashboard that is presented to local manufacturers according to one embodiment.

FIG. 7 depicts an exemplary computer system according to an embodiment.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details, or can be practiced with modifications or equivalents thereof.

Embodiments of the present disclosure provide a system for replenishing products that are being monitored by an internet-enabled device. An internet-enabled device is an electronic device that is capable of transmitting data through the internet. In some examples, the internet-enabled device can generate real-time consumption patterns or other replenishment data from the monitoring of a product and transmit the replenishment data to a cloud-based server for analysis.

The cloud-based server can process the replenishment data and determine whether the product needs to be replenished or replaced. If a determination is made that the product needs to be replenished or replaced, the cloud-based server can request bids from retailers. Each bid can represent the retailer's price for the product. Based on the bids, the cloud-based server can recommend one or more local retailers where the product (or an acceptable alternative) can be purchased. For example, the cloud-based server can recommend a local retailer where the consumer can purchase the item at the best price. As another example, the cloud-based server can recommend the closest local retailer to the consumer who has the product in stock.

The cloud-based server can also provide useful analysis for local retailers and manufacturers. For local retailers, the cloud-based server can provide insights on consumer consumption patterns. This can lead to optimization of inventory for each brand or product. For manufacturers, the cloud-based server can provide insights that are based on real-time consumption patterns. This can be useful for determining which products are popular at a particular geo-location. The manufacturer can produce more of the product locally or re-channel storage and distribution to focus on that particular geo-location. These and other aspects of the present disclosure are described in further detail in the sections that follow.

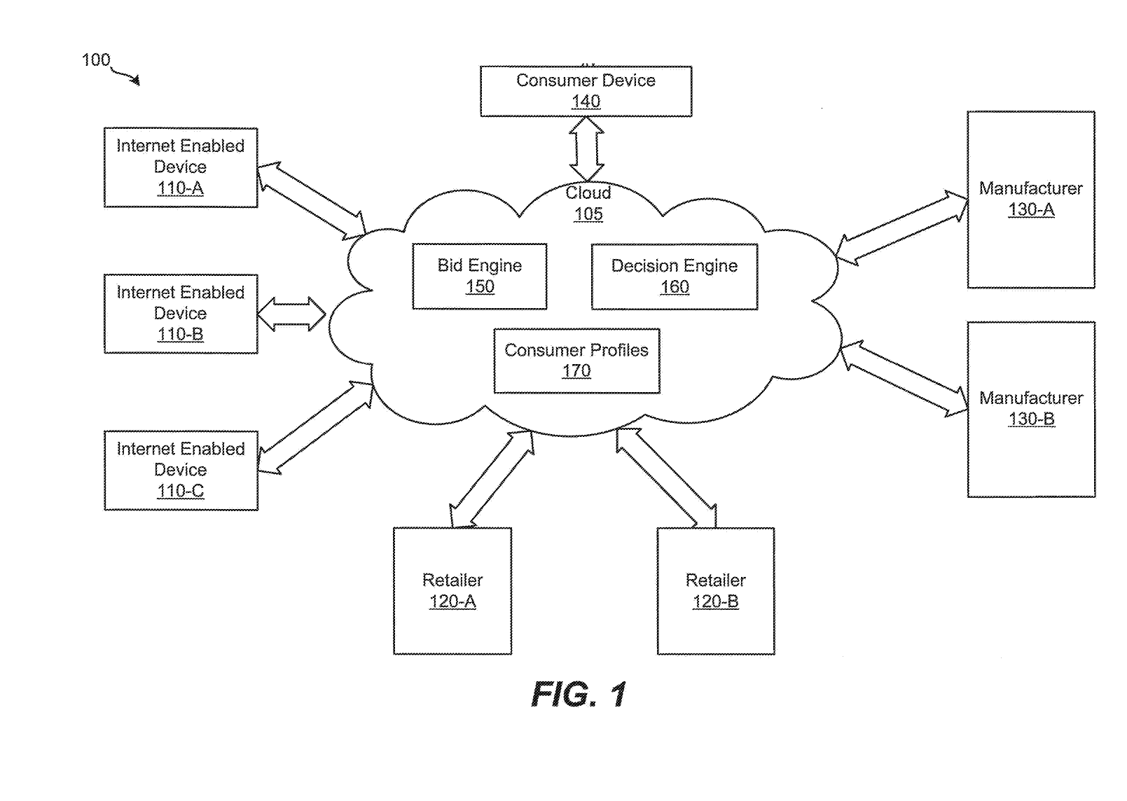

FIG. 1 depicts a system environment 100 for consumption pattern analysis according to one embodiment. As shown, system environment 100 includes cloud-based server 105. Cloud-based server 105 is configured to provide services to consumers, retailers, and manufacturers. For example, cloud-based server 105 can transmit notifications to consumer device 140 when a product being monitored by an internet enabled device (e.g., internet enabled device 110-A, 110-B, or 110-C) is almost depleted. The notification can include one or more recommended local retailers where the product can be purchased. A consumer operating consumer device 140 can review the notification and purchase the product at one of the recommended local retailers. Cloud-based server 105 can also transmit real-time feedback to retailers (e.g., retailers 120-A and 120-b) and manufacturers (e.g., manufacturers 130-A, and 130-B) on the consumption patterns of consumers. Advantages of this real-time feedback include allowing local retailers to better predict the products to stock on the stores and allowing manufacturers to optimize product creation, storage, and distribution. Since the insight is provided in response to replenishment data provided directly from the customer, the manufacturers may find the insight more accurate than feedback provided by the local retailers. Replenishment data can describe how much of the product has been used up, how much of the product is remaining, or the consumption rate of the product.

Cloud-based server 105 includes bid engine 150. Bid engine 150 is configured to process replenishment data from internet enabled devices 110 to determine which products being monitored by internet enabled devices 110 require replenishment. For example, processing of the replenishment data from internet enabled device 110-A can indicate that the product being monitored by internet enabled device 110-A requires replenishment. For products which require replenishment, bid engine 150 can subsequently transmit a notification to a consumer that consumes the product or that is responsible for replenishing the product. In one example, the notification can contain a list of local retailers where the product can be purchased. The notification can be transmitted to a consumer device belonging to a consumer that consumes the product or that is responsible for replenishing the product. The consumer can review the notification on the consumer device (e.g., smart phone, personal computer, etc.) and travel to one of the recommended local retailers to purchase the product. As one example, internet enabled device 110-A can be a smart refrigerator which is capable of monitoring the contents of perishables goods (such as milk) stored within the refrigerator. The smart refrigerator can periodically transmit replenishment data such as the amount of milk that has been consumed or the amount of milk that is still remaining. The smart refrigerator can be capable of monitoring multiple products which are stored within the refrigerator.

In one embodiment, bid engine 150 can take into consideration a consumer profile from consumer profiles 170 when analyzing the replenishment data. The consumer profile can provide information such as the consumer's product preferences or buying preferences. For example, a consumer profile can include data that the consumer prefers to buy milk brand A (i.e., product preference), the 2 percent fat variety (i.e., product preference), and in the gallon size (i.e., buying preference). The consumer profile can also include a purchase history by the consumer. The purchase history can be used to estimate the consumer's consumption levels. The purchase history can be also used to determine the consumer's preferred product brand and type. The purchase history can also be used to identify alternative products which may be acceptable to the consumer. For example, the purchase history can be analyzed to determine that the consumer frequently purchases milk brand A and thus milk brand A is the preferred brand. The purchase history can also be analyzed to determine that the consumer has occasionally purchased milk brand B and thus milk brand B is viable alternative brand for the consumer. In some examples, bid engine 150 can first determine the consumption pattern of the product for the particular consumer. For example, bid engine 150 can estimate the consumer consumes an estimated 12 ounces of milk a day. Based on the consumption pattern, bid engine 150 can determine whether the product replenishment is required. For example if there is only 36 ounces of milk left in the refrigerator and the consumer consumes an estimated 12 ounces of milk a day, then bid engine 150 can estimate that the milk will run out in 3 days. Based on the consumption pattern and the consumer profile (which states that the consumer prefers to have at least three days of milk in the refrigerator), bid engine 150 can recommend replenishing the product.

Cloud-based server 105 further includes decision engine 160. Decision engine 160 is configured to analyze consumer profiles to determine product consumption patterns on a per geo-location basis. In one embodiment, decision engine 160 can analyze the replenishment data received from internet enabled devices 110 and consumer profiles within consumer profiles 170 to determine a product consumption pattern. For example, a smart refrigerator can transmit replenishment data related to products stored within the smart refrigerator to decision engine 160. Decision engine 160 can determine the geo-location of the smart refrigerator and identify consumer profiles in consumer profiles 170 that are within a proximity of the geo-location of the smart refrigerator. Decision engine 160 can then determine the consumption pattern of a product being monitored within the refrigerator (such as milk) for the geo-location where the refrigerator is located. In some examples, the consumption pattern can be real-time since it is based on data being constantly received from the internet enabled devices.

Once the consumption pattern for the product has been determined, decision engine 160 can determine the amount of a given product that needs to be replenished in one or more geo-locations. For example, an analysis of all refrigerators within a geo-location can predict that 1000 gallons of milk is going to be purchased in the next week by consumers within that geolocation. Decision engine 160 can also predict upcoming demand for the products. Decision engine 160 can provide these insights to local retailers so that local retailers can optimize their inventory per brand or product. Decision engine 160 can also provide this insight to manufacturers. Manufacturers can take advantage of knowing the amount of products that are going to be replenished in a particular geolocation to optimize product production, transportation, storage, and/or distribution. Product demand can also be analyzed to optimize product production, transportation, storage, and/or distribution.

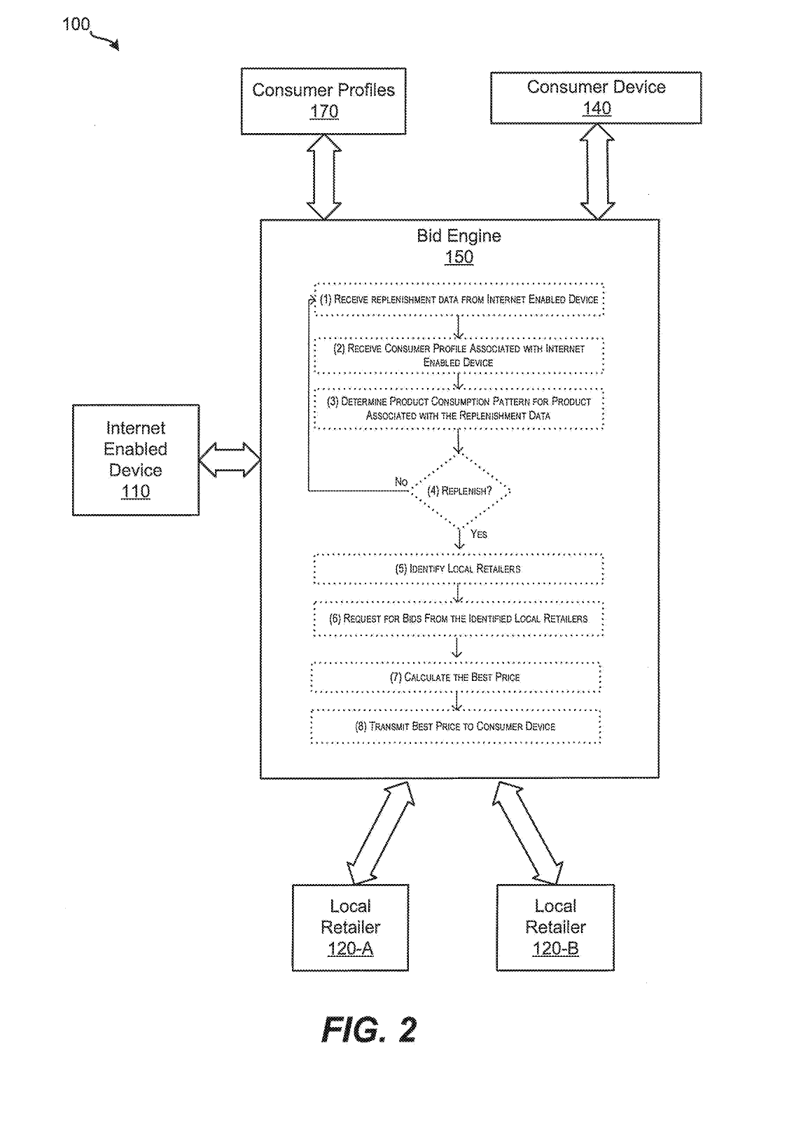

FIG. 2 depicts a system for assisting a consumer in purchasing products which need replenishment according to one embodiment. System 200 includes bid engine 150, internet enabled device 110, consumer profiles 170, consumer device 140, and local retailers 120-A and 120-B. Bid engine 150 is capable of processing replenishment data from internet enabled device 110 to identify one or more products being monitored that may require replenishment. Once the products have been identified, bid engine 150 can analyze local retailers 120-A and 120-B using predefined criteria and recommend a local retailer to purchase the product from. Exemplary criteria include lowest price, closest proximity to the consumer, closest proximity to the internet enabled device, or some combination of multiple criteria. The recommendation can be transmitted from bid engine 150 to consumer device 140 where the consumer can consume the recommendation.

As shown, bid engine 150 begins at step (1) by receiving replenishment data from internet enable device 110. Internet enabled device 110 can transmit replenishment data as the amount of product that remains or the amount of product that has been consumed. For example, a smart refrigerator can include sensors (e.g., cameras or scales) to monitor the amount of milk (or other product stored in the refrigerator) that is remaining. Measurements can be taken periodically and transmitted to bid engine 150. In one example, the product is stored within the internet enabled device. For instance, the product milk can be stored within an internet enabled refrigerator that is capable of monitoring the consumption of the milk. In another example, the product is being consumed by the internet enabled device. For instance, the product gas or oil can be consumed by an internet enabled vehicle that is capable of monitoring the consumption of the gas or oil. Once the replenishment data has been received, bid engine 150 can continue to step (2) by receiving a consumer profile that is associated with the internet enabled device 110. In one example, the consumer profile can belong to the consumer that owns internet enabled device 110. In another example, the consumer profile can belong to the consumer that consumes the product being monitored by internet enable device 110. The consumer profile can include data describing the buying patterns of the consumer or the consumption patterns of the consumer.

After receiving the consumer profile, bid engine 150 can continue to step (3) by determining a product consumption pattern for the product associated with the replenishment data. This determination can be made by evaluating the consumer profile to determine the rate in which the product is being consumed. For example, a product consumption pattern may indicate that the consumer consumes approximately 12 ounces of milk per day. As another example, a product consumption pattern may indicate approximately two eggs per day. In some embodiments, the consumption pattern can be generated based on the replenishment data and the consumer profile.

Once the consumption pattern has been determined, bid engine 150 can make a determination as to whether to replenish the product at step (4). A decision as to whether to replenish the product can be based on predefined criteria. In one embodiment, the criteria can be an estimate as to the number of days before the product is completely consumed. For example, one criteria can be that the product is to be replenished when there are two days remaining before the product is completely consumed. In the egg example above where an estimated two eggs are consumed per day, big engine 150 would make a determination to replenish the product when there are four eggs remaining in the smart refrigerator if the criteria specifies that the eggs shall be replenished two days before the eggs are completely consumed.

Bid engine 150 can continue by identifying local retailers at step (5) if a determination is made to replenish the product. In one embodiment, bid engine 150 can identify local retailers based on the geo-location of the consumer. For example, a geo-fence around the location of consumer device 140 can be used to locate local retailers that are within the geo-fence. This can be useful for identifying retailers that are close by the consumer so that the consumer can travel the minimum distance to purchase the product. In another embodiment, bid engine 150 can identify local retailers according to the geo-location of internet enabled device 110. For example, a geo-fence around the location of internet enabled device 110 can be used to locate local retailers that are within the geo-fence. This can be useful for identifying retailers that are local to the internet enabled device 110. For instance if the internet enabled device is monitoring the amount of oil within a vehicle, it may be useful to identify retailers close by the vehicle where the consumer can purchase oil. Similarly if the internet enabled device is monitoring tire wear, then it may be useful to identify tire shops where the vehicle can be brought into so that the consumer can purchase and install new tires on the vehicle. In yet another embodiment, bid engine 150 can identify local retailers based on the consumer profile. For example, the consumer profile can include the purchase history of the consumer. Through analysis of the purchase history, bid engine 150 can identify the preferred local retailers of the consumer. For instance, the purchase history can indicate that the consumer frequently purchases products from grocery store A but not grocery store B. As a result, grocery store A can be an identified local retailer for the consumer. In yet other embodiments, various combinations of the location of consumer device 140, internet enabled device 110, and the consumer profile can be used to identify local retailers.

Once the local retailers for the consumer have been identified, bid engine 150 can request for bids for the product from the identified local retailers at step (6). In one embodiment, bid engine 150 can determine the best price for the product. In one example, bid engine 150 can transmit a request to each identified local retailer requesting a bid price for the product. Each local retailer can in turn respond with their fixed price for the product. Bid engine 150 in turn can review the prices received in the responses and determine the best price for the product that is available from the identified local retailers. In another example, bid engine 150 can transmit the consumer's desired price (e.g., the price which the consumer is willing to pay) to each identified local retailer. Local retailers who are willing to sell the product at the consumer's desired price can transmit a response to bid engine 150. In yet another example, bid engine 150 can create an online auction for the product where each local retailer is a participant of the auction. Each participant can optionally submit a price to bid engine 150. For each price received, bid engine 150 can determine if the price is the best price for the product. If the price is the new best price, then bid engine 150 can update the best price and transmit the best price to all the identified local retailers. This process can repeat until no identified local retailers are willing to beat the current best price. This can be determined by waiting a predefined period of time for local retailers to submit prices for the product. For example if 5 minutes pass without any additional bids, then the current best price is the best price. In another embodiment, bid engine 150 can determine the best price for the product and/or a suitable or viable alternative for the product. The suitable or viable alternative can be determined by analyzing the consumer profile. In one example, the best price for the product and the viable alternative for the product are available from a local retailer and thus both are requested. In another example, the product may be unavailable so the best price for the viable alternative is determined. If the product is available, then the best price for the product is determined without consideration of the viable alternative.

After requesting bids from the identified local retailers, bid engine 150 can calculate the best price at step (7). If there are been multiple bids submitted, bid engine 150 can evaluate the multiple bids to determine the best price for the product. If prices for viable alternative products have also been received, the best price for a viable alternative of the product can also be generated. Once the best price for the product (and optionally the viable alternative) has been generated, bid engine 150 can transmit the best price (and optionally the viable alternative) to the consumer device at step (8). The consumer can in turn review the best price on the consumer device and go to a local retailer to purchase the product.

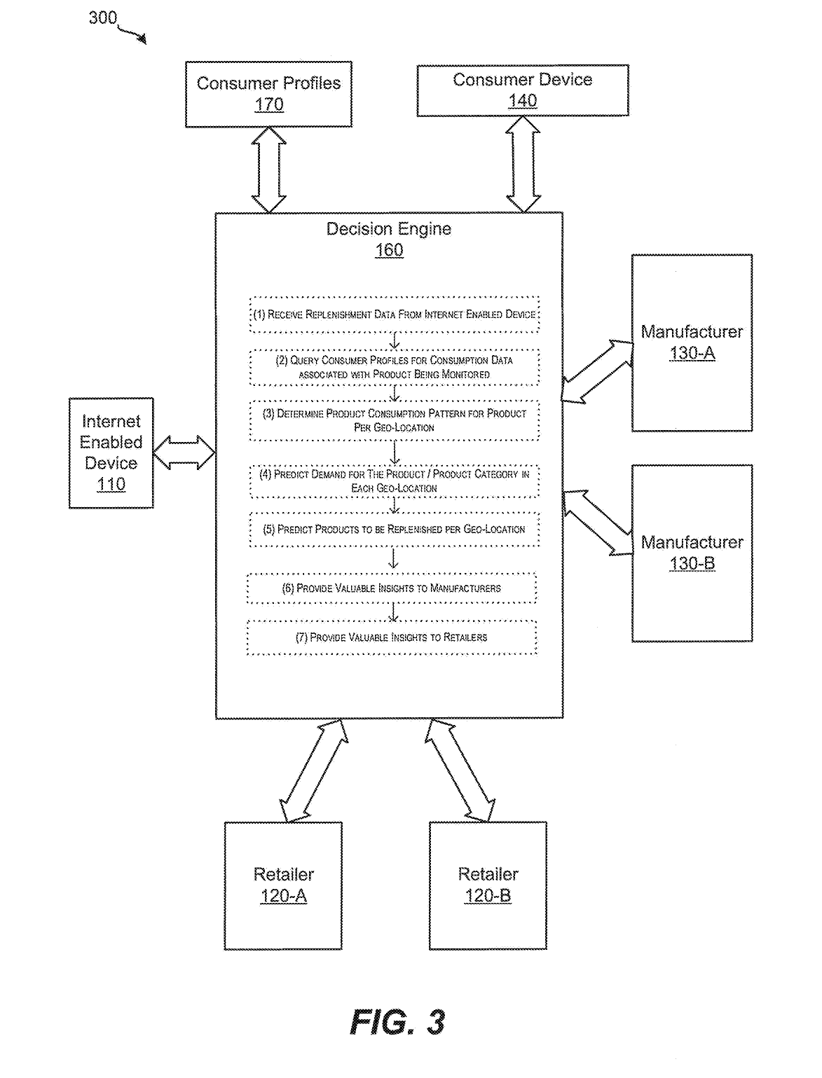

FIG. 3 depicts a system for providing useful insights to manufacturers and/or retailers according to one embodiment. System 300 includes decision engine 160, internet enabled device 110, consumer profiles 170, consumer device 140, local retailers 120-A and 120-B, and manufacturers 130-A and 130-B. Decision engine 160 is capable of processing consumer profiles (and replenishment data) to provide useful real-time insights to retailers and manufacturers. For retailers, decision engine 160 provides information on how to optimize the inventory of the brands and products which are in stock or provide information on the consumer's real-time consumption patterns. This allows retailers to more likely carry the products that are desired by the consumer and less likely have overstock of undesirable products.

For manufacturers, decision engine 160 provides information on the demand of product lines at particular geo-locations. For local manufacturers, this insight can allow the manufacturer to adjust product production based on real-time demand of the consumers. For example, let's assume a manufacturer can produce whole, 1%, and 2% milk. Depending on the consumer's real-time demands and the current stock of the manufacturer, the manufacturer can determine what types of milk need to be produced to meet the demand. For global manufacturers, this insight can allow the manufacturer to re-channel storage and distribution. For example, a global manufacturer can shift the stock of certain products to different locations based on the real-time demand of customers. This can ensure that local retailers are able to obtain the stock they desire.

As shown, decision engine 160 can begin at step (1) by receiving replenishment data form an internet enabled device. The replenishment data can serve as real-time consumption data that is being received from the consumers. This allows retailers and manufacturers evaluate the needs of the customer in real-time. In one example, the replenishment data can be related to a product that is being generated by the manufacturers and sold by the retailers. After receiving the replenishment data, decision engine 160 can query customer profiles for consumption data associated with the product being monitored by the internet enabled device. Consumer profiles database 170 can store multiple consumer profiles. Each consumer profile can store metadata on a consumer's consumption of one or more products. For example, the metadata can include the customer's product purchase history or the customer's rate of consumption for that particular product. The consumer profile can be retrieved from consumer profiles database 170. In one example, the consumer profile can belong to the owner of internet enabled device 110. In other examples, multiple consumer profiles can be retrieved from consumer profiles database 170. Once the consumer profile(s) have been received, decision engine 160 can determine product consumption pattern for products per geo-location at step (3). Decision engine 160 can create multiple geo-locations. The geo-locations can be overlapping or non-overlapping. Decision engine 160 can calculate the consumption pattern for the product in each geo-location. The consumption pattern can be an estimate on the rate of consumption for the product in that particular geo-location. The product consumption patterns can be generated from the consumer profile(s) and optionally the real-time replenishment data. For example, consumer profile data can be aggregated based on geo-location to identify the demand for products at particular geo-locations. In some examples, real-time replenishment data can be weighted over customer profile data. Based on the consumption patterns, decision engine 160 can predict the demand for each product or product category at step (4). In one embodiment, demand for each product category can be confined to the geo-location. Based on the demand, decision engine 160 can predict the products that are to be replenished in each geo-location at step (5). Analysis can be performed on the demand per geo-location to provide valuable insights to manufacturers at step (6) and to retailers at step (7).

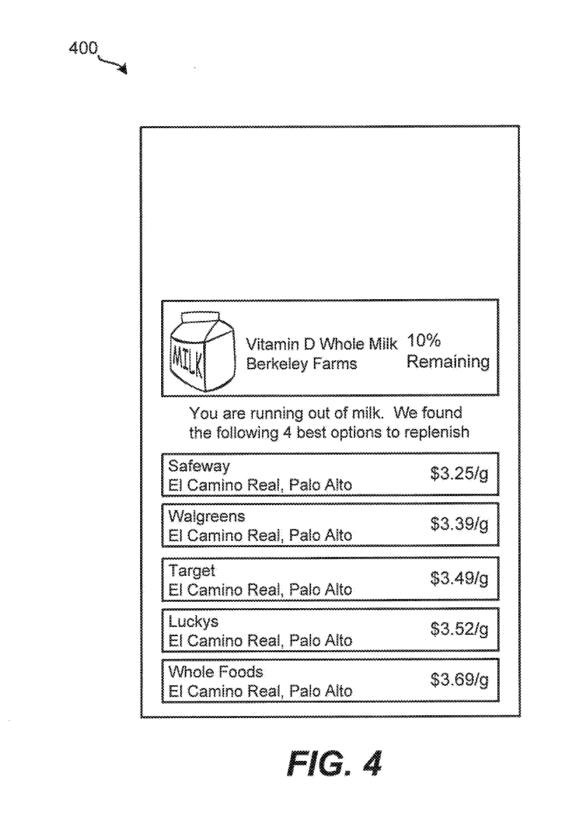

FIG. 4 depicts an example of a user interface presented on a consumer device according to one embodiment. As shown, user interface 400 is configured to notify the consumer of a milk product being monitored by an internet enabled device. User interface 400 includes a notification that the milk product needs to be replenished shortly. User interface 400 can present five local retailers as options where the desired milk product can be purchased. In one embodiment, selecting an option can result in user interface 400 being updated to present directions to the selected local retailer. In another embodiment, selecting the option can result in the consumer device reserving the products at the selected local retailer.

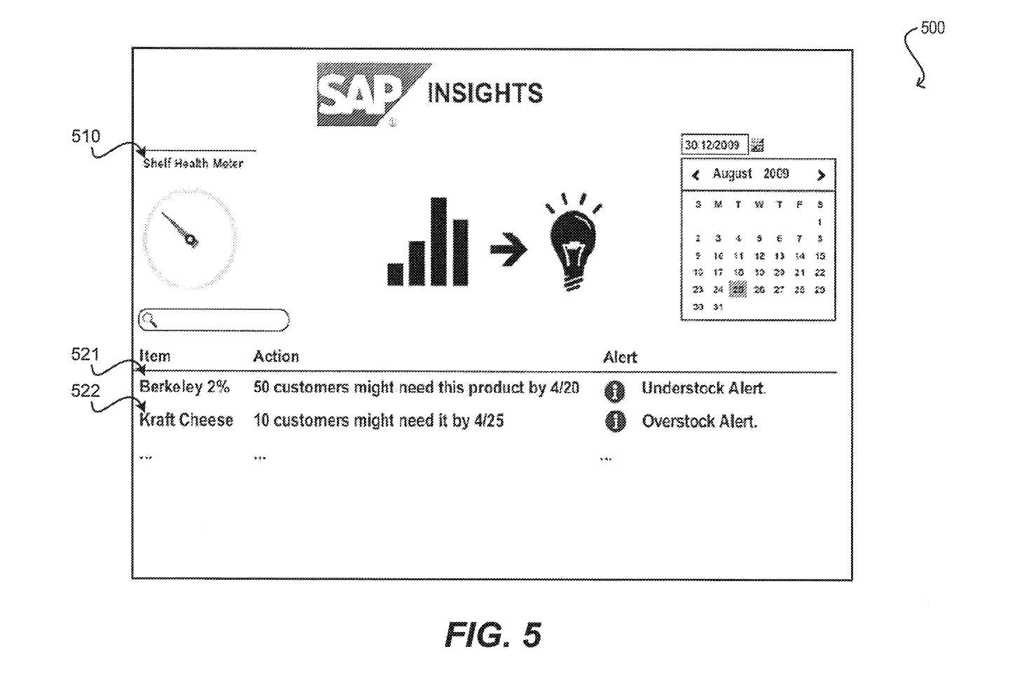

FIG. 5 depicts an example of a dashboard that is presented to local retailers according to one embodiment. Dashboard 500 includes graphic 510 that is configured to illustrate the quantity of stock within the store or stores of the local retailer. The quantity of stock can be measured based on a shelf score presented on a shelf health meter. The shelf score is a metric that describes the amount of product in stock that can be used to fill the shelves of the local retailers. Each local retailer can have a specified shelf layout for products. A healthy shelf score would indicate that there is sufficient stock to fill the shelves according to the shelf layout or a prediction that there is sufficient stock to fill shelves within the store(s) according to the shelf layout for a specified period of time. This means that for each type of product in the shelf layout, there is a sufficient quantity to fill the shelves according to the shelf layout. An unhealthy shelf score would indicate that there is insufficient stock to fill the shelves according to the shelf layout. For example, the stock may include an abundance of one product but a shortage of another product, thus resulting in an unhealthy shelf score.

Dashboard 500 further includes a table of products that are offered for sale at the retailer. Here, the table includes entry 521 and entry 522. Each entry can be associated with a product. For example, entry 521 is associated with Berkeley 2% Milk while entry 522 is associated with Kraft Cheese. The product can be presented in a first column of the entry. In some embodiments, each entry can further include a column for an action and another column for an alert. The action can predict the number of purchases for the product in a predefined period. The alert can provide a notification of whether the product is overstocked or understocked. An overstocked product is a prediction that there is more of the product in stock then can be sold in a predefined period of time. An understocked product is a prediction that there is not enough product in stock to keep the shelves stocked for a predefined period of time. For example, entry 521 has an action that 50 customers may need the product Berkeley 2% Milk by April 20^{th}. Given that the need (predicted 50 customers who want to purchase the product) surpasses or potentially depletes the available stock, an understock alert is generated. As another example, entry 522 has an action that 10 customers may need to purchase the product Kraft Cheese by April 25^{th}. Given that the need (predicted 10 customers who want to purchase the product) is low compared to amount of stock of Kraft Cheese available, an overstock alert is generated. In some embodiments, each product can have boundary conditions. For example, a product can have a first boundary condition to generate an understock alert (e.g., when a prediction estimates that there will be less than 5 items of the product in stock) and a second boundary condition to generate an overstock alert (e.g., when a prediction estimates that there will be more than 10 items of the product in stock). Each product can have different boundary conditions. For example, perishable products can have boundary conditions that generate a smaller acceptable range of stock (e.g., milk might have boundary conditions that create an acceptable range of stock as being 5-10 items) while non-perishable products can have boundary conditions that generate a larger acceptable range of stock (e.g., soda might have boundary conditions that create an acceptable range of stock as being 10-50 items).

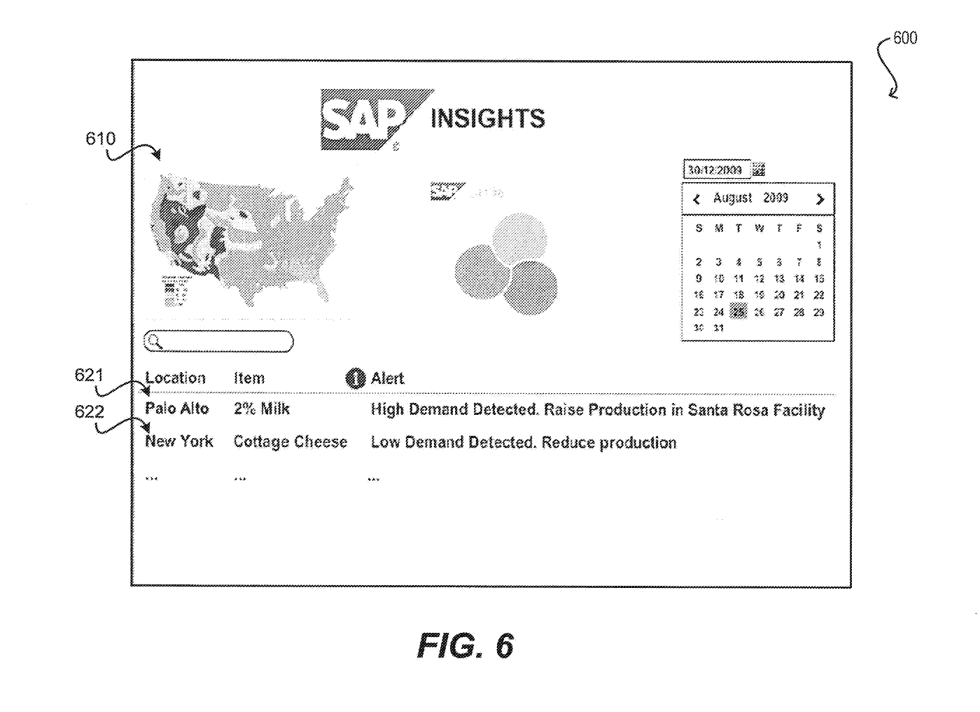

FIG. 6 depicts an example of a dashboard that is presented to local manufacturers according to one embodiment. Decision engine 160 can generate dashboard 600 based on customer profiles and replenishment data received from internet enabled devices. Dashboard 600 includes graphic 610 that is configured to illustrate a heat map of product demand at different geo-locations. The heat map can show the demand for a particular product across all geo-locations. Alternatively as shown here, the heat map can show an overall demand for all products across all geo-locations.

Dashboard 600 further includes a table. Each entry in the table identifies both a product that is being produced by the manufacturer and a geo-location having demand for that product. Each entry can also include an insight associated with the product at that geo-location. The insights can include changing production or re-channeling storage and distribution. For example, entry 621 provides an insight that high demand is detected for the product 2% milk at the Palo Alto geo-location. The insight can also provide a recommendation to raise product of the product in a facility nearby the geo-location. As another example, entry 622 provides an insight that low demand is detected for the product cottage cheese in the New York geo-location. The insight can also provide a recommendation to reduce production of the product. Other recommendations can include re-channeling distribution of the product to other geo-locations.

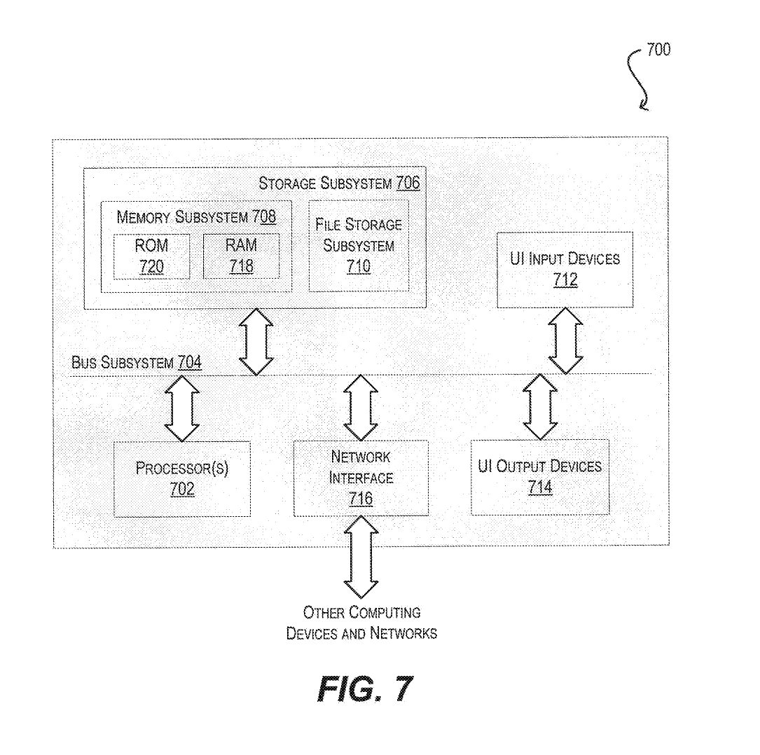

FIG. 7 depicts an exemplary computer system 700 according to an embodiment. Computer system 700 can be used to implement the various devices/systems described in the foregoing disclosure, such as the servers of server tier 104 and/or client devices 108(1)-108(N) of FIG. 1. As shown, computer system 700 includes one or more processors 702 that communicate with a number of peripheral devices via a bus subsystem 704. These peripheral devices include a storage subsystem 706 (comprising a memory subsystem 708 and a file storage subsystem 710), user interface input devices 712, user interface output devices 714, and a network interface subsystem 716.

Bus subsystem 704 can provide a mechanism for letting the various components and subsystems of computer system 700 communicate with each other as intended. Although bus subsystem 704 is shown schematically as a single bus, alternative embodiments of the bus subsystem can utilize multiple buses.

Network interface subsystem 716 can serve as an interface for communicating data between computer system 700 and other computing devices or networks. Embodiments of network interface subsystem 716 can include wired (e.g., coaxial, twisted pair, or fiber optic Ethernet) and/or wireless (e.g., Wi-Fi, cellular, Bluetooth, etc.) interfaces.

User interface input devices 712 can include a keyboard, pointing devices (e.g., mouse, trackball, touchpad, etc.), a scanner, a barcode scanner, a touch-screen incorporated into a display, audio input devices (e.g., voice recognition systems, microphones, etc.), and other types of input devices. In general, use of the term “input device” is intended to include all possible types of devices and mechanisms for inputting information into computer system 700.

User interface output devices 714 can include a display subsystem, a printer, a fax machine, or non-visual displays such as audio output devices, etc. The display subsystem can be a cathode ray tube (CRT), a flat-panel device such as a liquid crystal display (LCD), or a projection device. In general, use of the term “output device” is intended to include all possible types of devices and mechanisms for outputting information from computer system 700.

Storage subsystem 706 includes a memory subsystem 708 and a file/disk storage subsystem 710. Subsystems 708 and 710 represent non-transitory computer-readable storage media that can store program code and/or data that provide the functionality of various embodiments described herein.

Memory subsystem 708 can include a number of memories including a main random access memory (RAM) 718 for storage of instructions and data during program execution and a read-only memory (ROM) 720 in which fixed instructions are stored. File storage subsystem 710 can provide persistent (i.e., non-volatile) storage for program and data files and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 700 is illustrative and not intended to limit embodiments of the present invention. Many other configurations having more or fewer components than computer system 700 are possible.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. For example, although certain embodiments have been described with respect to particular process flows and steps, it should be apparent to those skilled in the art that the scope of the present invention is not strictly limited to the described flows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the invention as set forth in the following claims.

What is claimed is:

1. A computer implemented method comprising:
receiving, by a processor and from an internet enabled device, replenishment data associated with a first product being monitored by the internet enabled device;
generating, by the processor and in accordance to the replenishment data, a prediction that the first product is going to be depleted within a predefined period of time;
in response to the prediction, performing the steps of:
identifying, by the processor, a first plurality of retailers who carry the first product;
transmitting, by the processor, a request to the first plurality of retailers requesting a bid for the first product;
receiving, by the processor and from at least some of the first plurality of retailers, a price for the first product; and
generating, by the processor, a primary recommendation based on the plurality of prices for the first product, the recommendation being one of the first plurality of retailers.

2. The computer implemented method of claim 1, further comprising:
retreiving, by the processor, a user profile associated with the internet enabled device;
identifying, by the processor, a second product that is an alternative to the first product based on the user profile;
identifying, by the processor, a second plurality of retailers who carry the second product;
receiving, by the processor and from at least some of the second plurality of retailers, a price for the second product; and
generating, by the processor, a secondary recommendation based on the second plurality of prices for the second product.

3. The computer implemented method of claim 2, further comprising transmitting, by the processor, the primary recommendation and the secondary recommendation to a client device, the client device being operated by an owner of the internet enabled device.

4. The computer implemented method of claim 1, wherein the first product is stored within the internet enabled device.

5. The computer implemented method of claim 1, wherein the first product is being consumed by the internet enabled device.

6. The computer implemented method of claim 1, wherein the primary recommendation is dependent on the location of the internet enabled device.

7. The computer implemented method of claim 1, wherein the primary recommendation is the lowest price from the plurality of prices for the first product.

8. A non-transitory computer readable storage medium storing one or more programs, the one or more programs comprising instructions, which when executed by a processor, cause the processor to execute a method of:
receiving, from an internet enabled device, replenishment data associated with a first product being monitored by the internet enabled device;
generating, in accordance to the replenishment data, a prediction that the first product is going to be depleted within a predefined period of time;
in response to the prediction, performing the steps of:
identifying a first plurality of retailers who carry the first product;
transmitting a request to the first plurality of retailers requesting a bid for the first product;
receiving, from at least some of the first plurality of retailers, a price for the first product; and
generating a primary recommendation based on the plurality of prices for the first product, the recommendation being one of the first plurality of retailers.

9. The non-transitory computer readable storage medium of claim 8, further comprising:
retreiving a user profile associated with the internet enabled device;
identifying a second product that is an alternative to the first product based on the user profile;
identifying a second plurality of retailers who carry the second product;
receiving, from at least some of the second plurality of retailers, a price for the second product; and
generating a secondary recommendation based on the second plurality of prices for the second product.

10. The non-transitory computer readable storage medium of claim 9, further comprising transmitting the primary recommendation and the secondary recommendation to a client device, the client device being operated by an owner of the internet enabled device.

11. The non-transitory computer readable storage medium of claim 8, wherein the first product is stored within the internet enabled device.

12. The non-transitory computer readable storage medium of claim 8, wherein the first product is being consumed by the internet enabled device.

13. The non-transitory computer readable storage medium of claim 8, wherein the primary recommendation is dependent on the location of the internet enabled device.

14. The non-transitory computer readable storage medium of claim 8, wherein the primary recommendation is the lowest price from the plurality of prices for the first product.

15. A computer implemented system, comprising:
one or more computer processors; and
a non-transitory computer-readable storage medium comprising instructions, that when executed, control the one or more computer processors to be configured for:
receiving, from an internet enabled device, replenishment data associated with a first product being monitored by the internet enabled device;
generating, in accordance to the replenishment data, a prediction that the first product is going to be depleted within a predefined period of time;
in response to the prediction, performing the steps of:
identifying a first plurality of retailers who carry the first product;
transmitting a request to the first plurality of retailers requesting a bid for the first product;
receiving, from at least some of the first plurality of retailers, a price for the first product; and
generating a primary recommendation based on the plurality of prices for the first product, the recommendation being one of the first plurality of retailers.

16. The computer implemented system of claim 15, further comprising:
retreiving a user profile associated with the internet enabled device;
identifying a second product that is an alternative to the first product based on the user profile;
identifying a second plurality of retailers who carry the second product;
receiving, from at least some of the second plurality of retailers, a price for the second product; and
generating a secondary recommendation based on the second plurality of prices for the second product.

17. The computer implemented system of claim 16, further comprising transmitting the primary recommendation and the secondary recommendation to a client device, the client device being operated by an owner of the internet enabled device.

18. The computer implemented system of claim 15, wherein the first product is stored within the internet enabled device.

19. The computer implemented system of claim 15, wherein the first product is being consumed by the internet enabled device.

20. The computer implemented system of claim 15, wherein the primary recommendation is dependent on the location of the internet enabled device.
